(19) United States
(12) Patent Application Publication
(10) Pub. No.: US 2025/0289090 A1
(43) Pub. Date: Sep. 18, 2025

(54) APPARATUS FOR MEASURING THICKNESS OF WORKPIECE, METHOD FOR MEASURING THICKNESS OF WORKPIECE, AND SYSTEM FOR POLISHING WORKPIECE

(71) Applicant: SUMCO Corporation, Tokyo (JP)

(72) Inventors: Yuji MIYAZAKI, Tokyo (JP); Keiichi TAKANASHI, Tokyo (JP)

(73) Assignee: SUMCO Corporation, Tokyo (JP)

(21) Appl. No.: 18/863,173

(22) PCT Filed: Jul. 21, 2023
(86) PCT No.: PCT/JP2023/026872

§ 371 Date: Nov. 5, 2024

(30) Foreign Application Priority Data
Aug. 29, 2022 (JP) 2022-136161

(51) Int. Cl. B24B 49/12; B24B 7/22

(52) U.S. Cl. CPC B24B 49/12; B24B 7/228

(57) ABSTRACT

The apparatus for measuring a thickness of a workpiece of this disclosure comprises an enclosure; a measurement section disposed inside the enclosure for measuring the thickness of the workpiece; and a rectifier disposed inside the enclosure for rectifying airflow inside the enclosure, wherein the measurement section is provided with a spectral interferometric sensor. In the system for polishing a workpiece of this disclosure, the apparatus for measuring a thickness of a workpiece above is installed in each of the workpiece carry-in unit and the workpiece carry-out unit. In the method for measuring a thickness of a workpiece of this disclosure, the thickness of the workpiece is measured using a measurement section comprising a spectral interferometric sensor, the measurement section is disposed inside an enclosure, and the thickness of the workpiece is measured by the measurement section while rectifying airflow in the enclosure using a rectifier disposed inside the enclosure.

### TECHNICAL FIELD

This disclosure relates to an apparatus for measuring a thickness of a workpiece, a method for measuring a thickness of a workpiece, and a system for polishing a workpiece.

### BACKGROUND

There are two major methods for measuring a thickness of semiconductor wafers and other workpieces. One method is to measure the workpiece by setting displacement sensors on the front side and the back side of the workpiece, respectively, as illustrated in FIG. 1. In this method, the thickness of the workpiece can be calculated by subtracting the distance to the front surface of the workpiece and the distance to the back surface thereof from the distance between the two displacement sensors.

However, in this method, nm-order measurement is difficult with a simple design due to the axis misalignment of the two displacement sensors, vibration of the measurement drive unit, and thermal expansion around the measuring device.

The other method is to measure the workpiece using a spectral interferometric sensor, as illustrated in FIG. 2 (e.g., PTL 1). In this method, the thickness can be calculated by measuring the reflected light on the front and back surfaces of the workpiece by a laser emitted from the coaxial. This eliminates axial misalignment and vibration-induced displacement deviations, as in the aforementioned displacement meter.

### CITATION LIST

### Patent Literature

PTL 1: JP 2004-294155 A1

### SUMMARY

### Technical Problem

However, since spectral interferometric sensors are transmission sensors, the measurement results are affected by the refractive index, a physical property of the workpiece. In particular, temperature affects the refractive index. If a temperature change has occurred during the measurement of the workpiece, this will result in errors in the measured thickness. As represented in FIG. 3, there is a positive correlation between the temperature of the workpiece and the measured thickness of the workpiece, and it can be seen that the higher the temperature of the workpiece, the thicker the thickness of the workpiece is measured as a measurement value.

In response to this problem, the purpose of the present disclosure is to provide an apparatus for measuring a thickness of a workpiece, a method for measuring a thickness of a workpiece, and a system for polishing a workpiece, that can accurately measure the thickness of the workpiece when a spectral interferometric sensor is used.

### Solution to Problem

The gist structure of the present disclosure is as follows.

(1) An apparatus for measuring a thickness of a workpiece, comprising
an enclosure;
a measurement section disposed inside the enclosure for measuring the thickness of the workpiece; and
a rectifier disposed inside the enclosure for rectifying airflow inside the enclosure,
wherein the measurement section is provided with a spectral interferometric sensor.

(2) The apparatus for measuring a thickness of a workpiece according to (1) above, further comprising a storage section for storing equipment.

(3) The apparatus for measuring a thickness of a workpiece according to (2) above, wherein the rectifier, the measurement section, and the storage section are arranged in this order from an upper side in the enclosure,
a first partition is provided between the rectifier and the measurement section,
a second partition is provided between the measurement section and the storage section,
a first opening is provided in the first partition, and
a second opening is provided in the second partition.

(4) The apparatus for measuring a thickness of a workpiece according to (3) above, wherein the second partition with the second opening is a perforated plate.

(5) The apparatus for measuring a thickness of a workpiece according to (2) or (3) above, wherein an exhaust slit is provided on a side portion of the enclosure that defines the storage section.

(6) The apparatus for measuring a thickness of a workpiece according to any one of (1) to (5) above, wherein a bottom portion of the enclosure is made of a perforated plate.

(7) The apparatus for measuring a thickness of a workpiece according to any one of (1) to (6) above, wherein a temperature sensor is disposed at least inside the enclosure.

(8) The apparatus for measuring a thickness of a workpiece according to any one of (1) to (7) above, wherein the workpiece is a semiconductor wafer.

(9) A system for polishing a workpiece, comprising a workpiece carry-in unit and a workpiece carry-out unit,
wherein the apparatus for measuring a thickness of a workpiece according to any one of claims 1 to 8 is installed in each of the workpiece carry-in and the workpiece carry-out unit.

(10) The system for polishing a workpiece according to (9) above, further comprising a polishing unit, a cleaning unit, and a drying unit.

(11) The system for polishing a workpiece according to (9) or (10) above, wherein the workpiece is a semiconductor wafer.

(12) A method for measuring a thickness of a workpiece in which the thickness of the workpiece is measured using a measurement section comprising a spectral interferometric sensor, wherein
the measurement section is disposed inside an enclosure, and
the thickness of the workpiece is measured by the measurement section while rectifying airflow in the enclosure using a rectifier disposed inside the enclosure.

(13) The method for measuring a thickness of a workpiece according to (12) above, including
monitoring a temperature of at least inside the enclosure by a temperature sensor disposed at least inside the enclosure, and estimating an appropriate measurement time for measuring the thickness of the workpiece based on a result of the monitored temperature measurement, and
measuring the thickness of the workpiece with the estimated measurement time.

(14) The method for measuring a thickness of a workpiece according to (12) above, including
monitoring a temperature of at least inside the enclosure by a temperature sensor disposed at least inside the enclosure, and determining pass or fail on measurement accuracy based on a result of the monitored temperature measurement.

(15) The method for measuring a thickness of a workpiece according to (12) or (13) above, wherein the workpiece is a semiconductor wafer.

### Advantageous Effect

According to the present disclosure, it is possible to provide an apparatus and a method for measuring a thickness of a workpiece, and a system for polishing a workpiece, that can accurately measure the thickness of the workpiece when a spectral interferometric sensor is used.

### BRIEF DESCRIPTION OF THE DRAWINGS

In the accompanying drawings:

FIG. 1 is a schematic illustration when a thickness of a workpiece is measured by placing it between displacement sensors;

FIG. 2 is a schematic illustration when a thickness of a workpiece is measured by a spectral interferometric sensor;

FIG. 3 is a graph representing the relationship between the temperature of workpieces and the measured thickness of the workpieces;

FIG. 4A is a schematic perspective view of an apparatus for measuring a thickness of a workpiece according to one embodiment of the present disclosure;

FIG. 4B is a drawing for explaining the airflow in an enclosure of the apparatus in FIG. 4A;

FIG. 4C is a transparent perspective view seen through the apparatus in FIG. 4A;

FIG. 5 is a schematic transparent perspective view of an apparatus for measuring a thickness of a workpiece in a modified example;

FIG. 6 is a graph representing the relationship between the measurement time for measuring the thickness of the workpiece and the variation in ambient temperature (6σ);

FIG. 7 is a top view and a bottom view of a system for polishing a workpiece according to one embodiment of the present disclosure;

FIG. 8 is a graph representing the change over time in temperature inside and outside an enclosure in a case of Example according to the present disclosure;

FIG. 9 is a graph representing the difference between the temperature in FIG. 8 and the temperature 10 seconds earlier in FIG. 8;

FIG. 10 is a graph representing the change in temperature inside an enclosure when the measurement time for measuring the thickness of the workpiece is 10, 30, 60, and 120 seconds;

FIG. 11 is a graph representing the relationship between the GBIR value results in Examples and the GBIR value results from the flatness measuring instrument (WaferSight); and

FIG. 12 is a graph representing the relationship between the GBIR value results in Comparative Examples and the GBIR value results from the flatness measuring instrument (WaferSight).

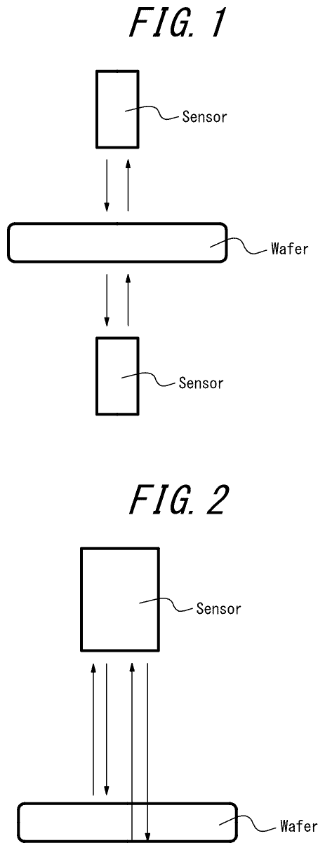

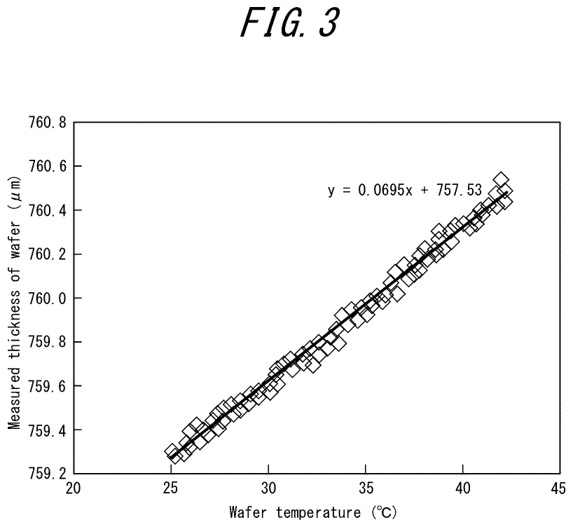

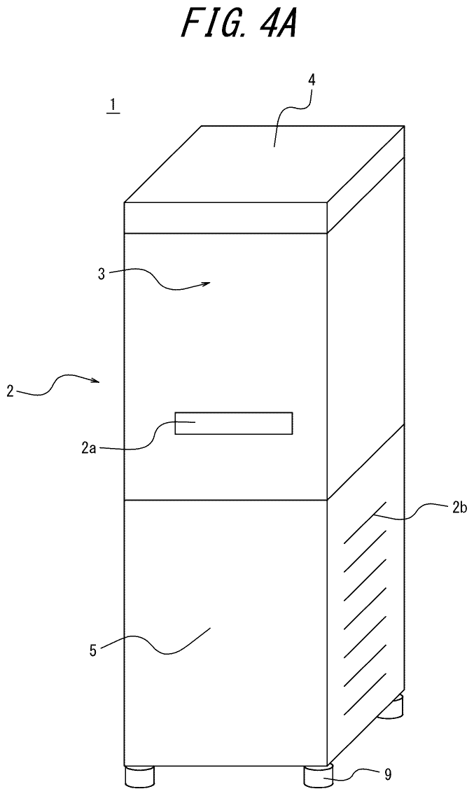

### DETAILED DESCRIPTION

Hereinafter, embodiments of the present disclosure will be described in detail with reference to the drawings.

### <Apparatus for Measuring Thickness of Workpiece>

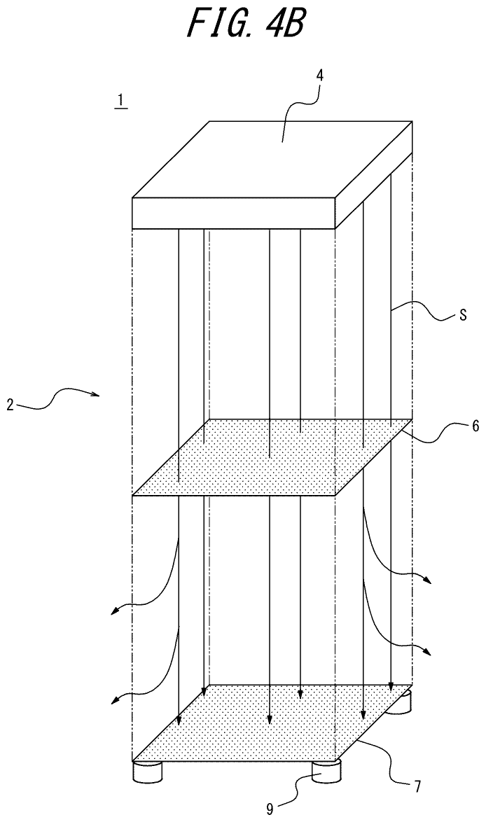

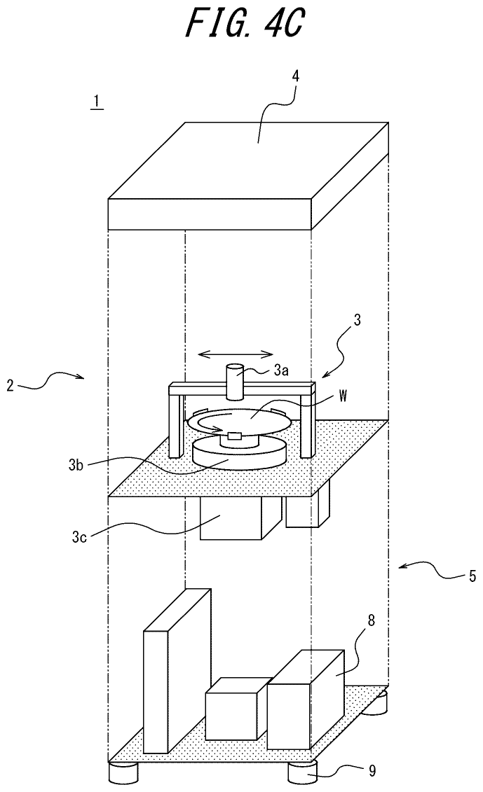

FIG. 4A is a schematic perspective view of an apparatus for measuring a thickness of a workpiece according to one embodiment of the present disclosure. FIG. 4B is a drawing for explaining the airflow in an enclosure of the apparatus in FIG. 4A. FIG. 4C is a transparent perspective view seen through the apparatus in FIG. 4A.

As illustrated in FIGS. 4A to 4C, an apparatus 1 for measuring a thickness of a workpiece of this embodiment comprises an enclosure 2, a measurement section 3 disposed inside the enclosure 2 for measuring the thickness of the workpiece, and a rectifier 4 disposed inside the enclosure 2 for rectifying the airflow within the enclosure 2. In addition, the apparatus 1 comprises, in the illustrated example, a storage section 5 for storing equipment 8.

In the illustrated example, the rectifier 4, the measurement section 3, and the storage section 5 are arranged in this order from an upper side in the enclosure 2. There is a first partition (not illustrated) between the rectifier 4 and the measurement section 3, and a second partition 6 between the measurement section 3 and the storage section 5.

The enclosure 2 is box-shaped and large enough to house the rectifier 4, the measurement section 3, and the equipment 8. In this example, the enclosure 2 is preferably made of a material with little temperature change, for example, a SUS plate with a heat insulator attached to it. On the part of the enclosure 2 that defines the measurement section 3, a carry-in port 2a where a workpiece (in this example, a semiconductor silicon wafer) to be subjected to the thickness measurement can be carried in is provided. In addition, on the side portion of the enclosure 2 that defines the storage section 5, a plurality of exhaust slits 2b are provided. In particular, the bottom portion of the enclosure 2 is made of a perforated plate 7. As mentioned above, the enclosure 2 is divided into three parts, by the first partition and the second partition 6, the rectifier 4, the measurement section 3, and the storage section 5. In this embodiment, the first partition is provided with a (plurality of) first opening(s) (in this example, the first partition is made of a perforated plate), and the second partition 6 is provided with a (plurality of) second opening(s) (in this example, the second partition 6 is made of a perforated plate. This allows the enclosure 2 to have good ventilation between the rectifier 4, the measurement section 3, and the storage section 5. Furthermore, the exhaust slits 2b on the side portion of the storage section 5 and the perforated plate 7 at the bottom portion allow sufficient exhaust to the outside of the enclosure 2.

The measurement section 3 comprises a spectral interferometric sensor 3a. The spectral interferometric sensor 3a is configured to be movable in the radial direction of the workpiece W. The measurement section 3, in this example, further comprises a holding section 3b on which the workpiece W can be rotatably placed, and a drive section (rotation motor) 3c that rotates the workpiece W by rotating the holding section 3b. By placing the workpiece W on the holding section 3b and rotating the workpiece W by rotating the holding section 3b with the drive section 3c while moving the spectral interferometric sensor 3a in the radial direction of the workpiece W, the measuring points on the plane of the workpiece W form a spiral orbit, which enables efficient measurement of the thickness of the workpiece W. As the spectral interferometric sensor 3a, a known spectral interferometric sensor can be used.

The rectifier 4 is configured to rectify the airflow S in the enclosure 2. As the rectifier 4A, a known fan filter unit (FFU) can be used. As FIG. 4B illustrates the flow of the airflow S, when air is blown downward from the rectifier 4 installed on the upper side in the enclosure 2, the airflow S passes through the rectifier 4, the measurement section 3, and the storage section 5 because, as mentioned above, the enclosure 2 is well ventilated between the rectifier 4, the measurement section 3, and the storage section 5, and further, the air is exhausted to the outside of the enclosure 2 by the exhaust slit 2b on the side portion of the storage section 5 and the holes in the perforated plate 7 at the bottom portion. This prevents air stagnation in the enclosure 2. Note, that the FFU is preferably set at a wind speed of 0.3 to 1.5 m/sec, although it is not limited.

Examples of the equipment 8 include a power supply that supplies power to the drive section 3c, etc., a computer that records the measurement results of the thickness of the workpiece, a control PLC for motors, etc., and measurement equipment (light source and power supply) for measuring the thickness of the workpiece. The bottom portion of the enclosure 2 (bottom surface of the punching plate 7) is provided with a vibration-isolation mechanism 9, which allows the measurement of the thickness of the workpiece in the enclosure 2 with reduced vibration. A small cylindrical vibration-isolation mechanism 9, as illustrated in the figure, is easy to install in existing facilities.

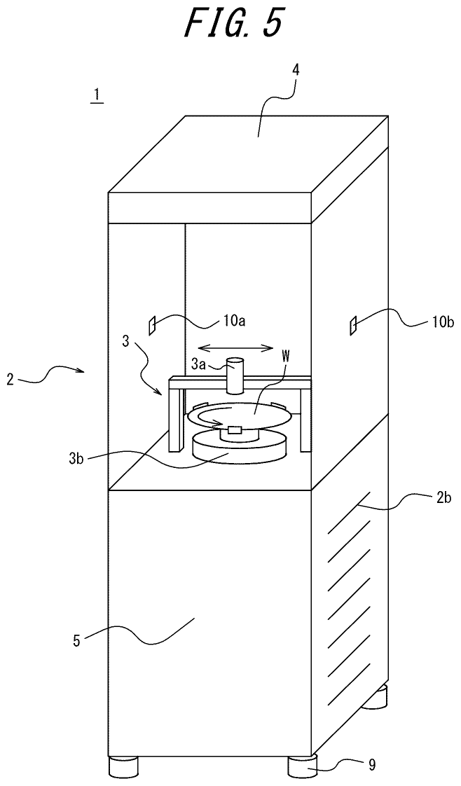

FIG. 5 is a schematic transparent perspective view of an apparatus for measuring a thickness of a workpiece in a modified example. As illustrated in FIG. 5, temperature sensors (thermocouples in this example) 10a and 10b may be disposed inside and outside the enclosure 2. In the illustrated example, the thermocouple 10a is installed inside the portion of the enclosure 2 that defines the measurement section 3, and the thermocouple 10b is installed outside the portion of the enclosure 2 that defines the measurement section 3. This allows monitoring the respective temperatures inside and outside the enclosure 2 (the measurement section 3 in the illustrated example).

The following is an explanation of the effects of the apparatus for measuring a thickness of a workpiece according to this embodiment.

The apparatus 1 for measuring a thickness of a workpiece of this embodiment comprises the rectifier 4 which is disposed inside the enclosure 2 and rectifies the airflow in the enclosure 2 (especially, the measurement section 3), thus, as illustrated in FIG. 4B, the airflow S in the enclosure 2 (especially, the measurement section 3) can be rectified so that no air stagnation occurs in the enclosure 2 (especially, the measurement section 3). This allows the temperature change inside the enclosure 2 (especially, the measurement section 3) to be reduced in comparison with the temperature change outside the enclosure 2, thereby reducing the error in the measured thickness of the workpiece when using a spectral interferometric sensor due to the temperature change in the measurement environment.

Thus, according to the apparatus 1 for measuring a thickness of a workpiece of this embodiment, it is possible to accurately measure the thickness of the workpiece when a spectral interferometric sensor is used.

As in this embodiment, the apparatus 1 for measuring a thickness of a workpiece preferably comprises the storage section 5 for storing the equipment 8. Especially, it is preferable that: the rectifier 4, the measurement section 3, and the storage section 5 are arranged in this order from the upper side in the enclosure 2; the first partition is provided between the rectifier 4 and the measurement section 3; the second partition is provided between the measurement section 3 and the storage section 5; the first opening is provided in the first partition; and the second opening is provided in the second partition. Since this allows the airflow S in the measurement section 3 to be rectified to a nearly top-to-bottom flow, as illustrated in FIG. 4B, the temperature change within the measuring section 3 can be further reduced, enabling more accurate measurement of the thickness of the workpiece. For this reason, it is more preferable that the second partition 6 with the second opening be made of a perforated plate. This is because it allows good ventilation from the measurement section 3 to the storage section 5.

Since the storage section 5 contains the equipment 8 and heat is generated by the equipment 8, it is preferable to provide the exhaust slit 2b in the side portion of the enclosure 2 that defines the storage section 5. This is because this ensures the flow of the airflow S from inside the enclosure 2 to outside the enclosure 2, while preventing heat buildup in the storage section 5. For the same reason, the bottom portion of the enclosure 2 is preferably made of a perforated plate.

When the first partition, the second partition 6, and the bottom portion of the enclosure 2 are made of a perforated plate, the ratio of the total area of the openings to the total area of the perforated plate (assuming no holes) is preferably between 30% or more and 50% or less, although there is no particular limitation, and the holes are preferably uniformly distributed on the perforated plate.

Also, in the exhaust slit 2b, the ratio of the total area of the openings of the slit to the total area of the side portion of the enclosure 2 that defines the storage section 5 (assuming no slit) is preferably between 5% or more and 30% or less. Although not limited as it depends on the size of the enclosure 2, the length of the slit is preferably 100 to 400 mm and the width of the slit is preferably 5 to 10 mm.

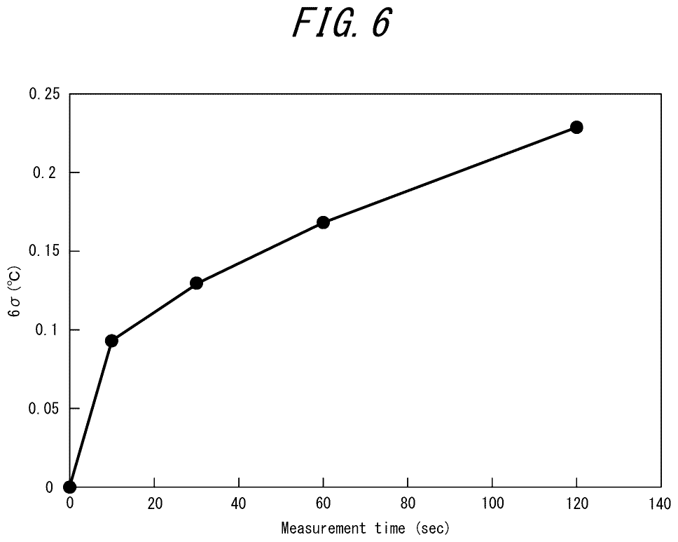

In addition, as illustrated in FIG. 5, in the apparatus 1 for measuring a thickness of a workpiece, the temperature sensor 10a (10b) is preferably disposed at least inside (in this example, inside and outside, respectively) the enclosure 2. This allows the temperature sensor 10a to monitor the temperature inside the enclosure 2 (the measurement section 3, in the illustrated example). FIG. 6 is a graph representing the relationship between the measurement time for measuring the thickness of the workpiece and the variation in ambient temperature (6σ). As illustrated in FIG. 6, the temperature variation increases with time. Longer measurement time for measuring the thickness of the workpiece is preferable from the standpoint of obtaining more measurement points, but there is also the problem of reduced measurement accuracy due to the greater temperature variation. Therefore, by setting in advance a reference value for the allowable variation in the temperature of the enclosure 2 (the measurement section 3, in the illustrated example), measuring for as long as possible, and increasing the number of measuring points, the measurement accuracy of the thickness of the workpiece can be further improved.

Thus, based on the result of the monitored temperature measurement, an appropriate measurement time for measuring the thickness of the workpiece can be estimated, and the thickness of the workpiece can be measured at the estimated measurement time.

By providing the temperature sensor 10b also outside the enclosure 2, as in this example, the output of the rectifier 4 can also be adjusted accordingly, based on figuring out of how much the temperature change inside is reduced compared to the temperature change outside.

In addition, it is also possible to monitor the temperature of at least inside (in this example, inside and outside, respectively) the enclosure 2 by the temperature sensors 10a (10b) disposed at least inside (in this example, inside and outside, respectively) the enclosure, and determining pass or fail on measurement accuracy based on the result of the monitored temperature measurement. This allows for eliminating of less accurate measurements. This determination on pass or fail may be based solely on the temperature change inside, or it may take into account the relative relationship with the temperature change outside. When the relative relationship with the temperature change outside is also considered, it can also help to pinpoint the cause of the large temperature change: for example, if the temperature change is large only inside, it can be considered as an internal factor, and if the temperature change is large both inside and outside, it can be considered as an external factor.

### <System for Polishing Workpiece>

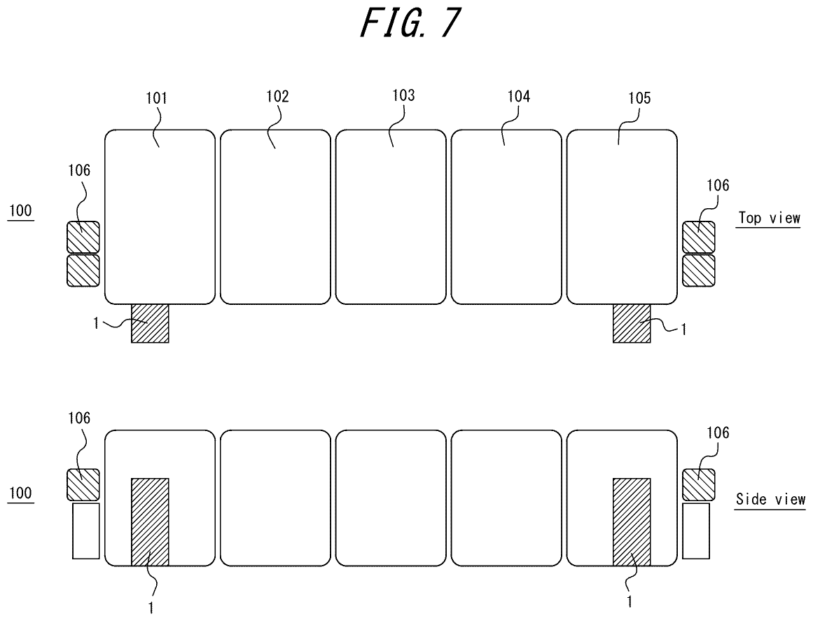

FIG. 7 is a top view and a bottom view of a system 100 for polishing a workpiece according to one embodiment of the present disclosure. In this system 100, a workpiece carry-in unit 101, a polishing unit 102, a cleaning unit 103, a drying unit 104, and a workpiece carry-out unit 105 are disposed in this order, according to customary practice. A FOUP (Front-Opening Unified Pod) 106 is disposed at the front of the workpiece carry-in unit 101 and at the rear of the workpiece carry-out unit 105. A workpiece W (in this example, a semiconductor silicon wafer) is removed from the FOUP 106 in which the workpiece W is housed. The workpiece W which is taken out is carried into the workpiece carry-in unit 101. Then, the workpiece W is polished in the workpiece polishing unit 102; followed by washing the workpiece W after polishing in the workpiece cleaning unit 103; followed by drying the workpiece W after cleaning in the drying unit 104; and then the workpiece W is carried out from the workpiece carry-out unit 105. The workpiece W that has been carried out is again housed in the FOUP 106. Each unit can be of a known configuration.

Here, in this embodiment, the apparatus 1 for measuring a thickness of a workpiece is installed in each of the workpiece carry-in unit 101 and the workpiece carry-out unit 105. The configuration of the apparatus 1 for measuring a thickness of a workpiece has already been described in the embodiment of the apparatus for measuring a thickness of a workpiece.

According to the system 100 for polishing a workpiece, the thickness of the workpiece can be accurately measured by the apparatus 1 for measuring a thickness of a workpiece in the same way as already described in the embodiment of the apparatus for measuring a thickness of a workpiece. In addition, because the apparatus 1 for measuring a thickness of a workpiece is installed in each of the workpiece carry-in unit 101 and the workpiece carry-out unit 105, the thickness of the workpiece before and after polishing can be measured with high accuracy, which allows, for example, the amount of polishing to be calculated with high accuracy.

### <Method for Measuring Thickness of Workpiece>

First, the method of measuring a thickness of a workpiece of this embodiment can be performed using the apparatus 1 described in the embodiment of the apparatus for measuring a thickness of a workpiece.

In the method for measuring a thickness of a workpiece of this embodiment, the thickness of the workpiece W is measured using a measurement section 3 comprising a spectral interferometric sensor. The measurement section 3 is disposed inside an enclosure 2, and the thickness of the workpiece W is measured by the measurement section 3 while rectifying airflow in the enclosure 2 using a rectifier 4 disposed inside the enclosure 2. As described in the embodiment of the apparatus for measuring a thickness of a workpiece, this allows measurement to be performed while reducing the temperature change inside the enclosure 2 (especially, the measurement section 3) in comparison with the temperature change outside the enclosure 2, thereby reducing the error in the measured thickness of the workpiece when using a spectral interferometric sensor due to the temperature change in the measurement environment.

Thus, according to the method for measuring a thickness of a workpiece of this embodiment, it is possible to accurately measure the thickness of the workpiece when a spectral interferometric sensor is used.

Here, it is preferable to include monitoring a temperature of at least inside (in this example, inside and outside, respectively) the enclosure 2 by a temperature sensor 10a (10b) disposed at least inside (in this example, inside and outside, respectively) the enclosure 2, and estimating an appropriate measurement time for measuring the thickness of the workpiece W based on a result of the monitored temperature measurement, and measuring the thickness of the workpiece W with the estimated measurement time. This is because, as explained in the embodiment of the apparatus for measuring a thickness of a workpiece W, longer measurement time and more measurement points as much as possible will allow for more accurate measurements.

In addition, it is also preferable to include monitoring a temperature of at least inside (in this example, inside and outside, respectively) the enclosure 2 by a temperature sensor disposed at least inside (in this example, inside and outside, respectively) the enclosure 2, and determining pass or fail on measurement accuracy based on a result of the monitored temperature measurement. This allows for the elimination of less accurate measurements.

### EXAMPLES

In order to verify the effectiveness of the present disclosure, a comparison experiment was conducted between the case using the apparatus for measuring a thickness of a workpiece illustrated in FIGS. 4A through 4C (Example) and the case using a general clean room (Comparative Example).

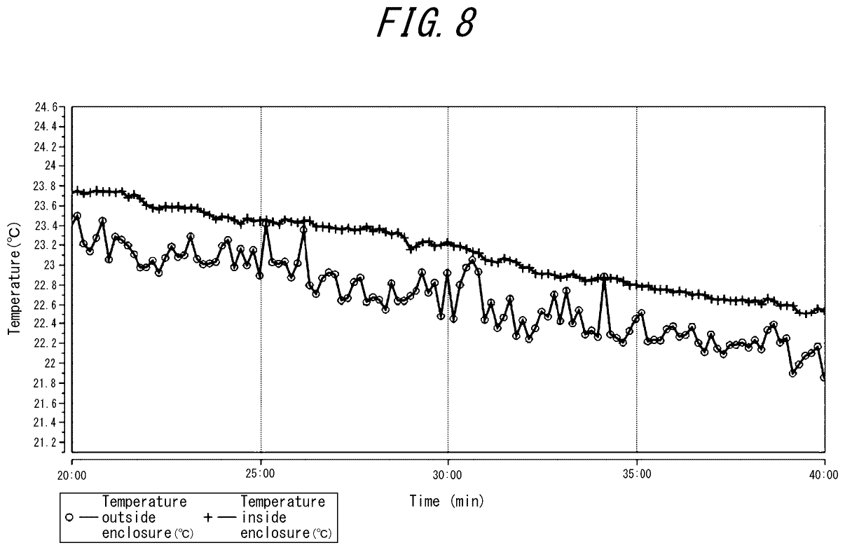

FIG. 8 is a graph representing the change over time in temperature inside and outside the enclosure 2 in a case of the present disclosure. Note, that the rectifier 4 was turned on. As indicated in FIG. 8, the temperature inside enclosure 2, when compared to the outside, shares the same tendency of decreasing with time, but the variation over a short period of time is small.

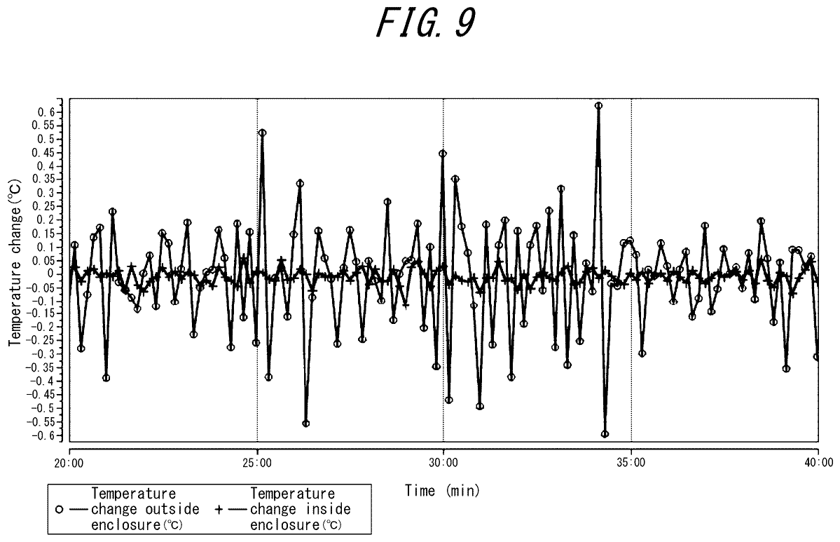

To make the above point clearer, FIG. 9 is a graph representing the difference between the temperature in FIG. 8 and the temperature 10 seconds earlier in FIG. 8. It can be seen that the temperature change inside the enclosure 2 over a time period of about 10 seconds is small compared to outside the enclosure 2. From this, it can be inferred that the change in airflow due to external disturbances generates a change in temperature outside, while rectification controls it inside.

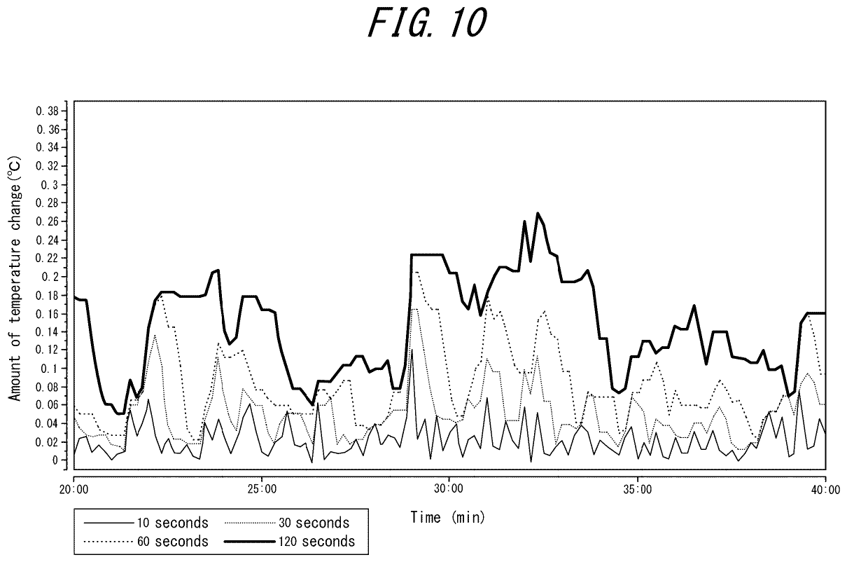

FIG. 10 is a graph representing the change in temperature inside the enclosure when the measurement time for measuring the thickness of the workpiece is 10, 30, 60, and 120 seconds. As indicated in FIG. 10, the temperature change is controlled inside the enclosure, but the control is more effective when the measurement time is shorter. This is indicated in FIG. 6 above in terms of the relationship between the measurement time and the variation in temperature change (6σ). With reference to this, for example, if the reference value of 6σ is set to 0.2, approximately 90 seconds can be estimated as the measurement time.

Next, the thickness of the workpiece (semiconductor silicon wafer with a diameter of 300 mm) was measured using a spectral interferometric sensor in a case of Example and Comparative Example. The measurement was performed by placing the workpiece on the holding section and rotating the workpiece by rotating the holding section with the drive section while moving the spectral interferometric sensor in the radial direction of the workpiece, so that the measuring points on the plane of the workpiece W form a spiral orbit, or spiral measurement. The measurement was performed at a pitch of 1 mm, a rotation speed of 30 rpm, and a measurement time of 60 seconds. Separately, measurement by a flatness measuring instrument (WaferSight) was performed, and this result was taken as correct. The higher the correlation with the measurement by the flatness measuring instrument (WaferSight), the more accurate the measurement of the thickness of the workpiece. GBIR (Global flatness Back reference Ideal Range) values were calculated from the obtained measurements.

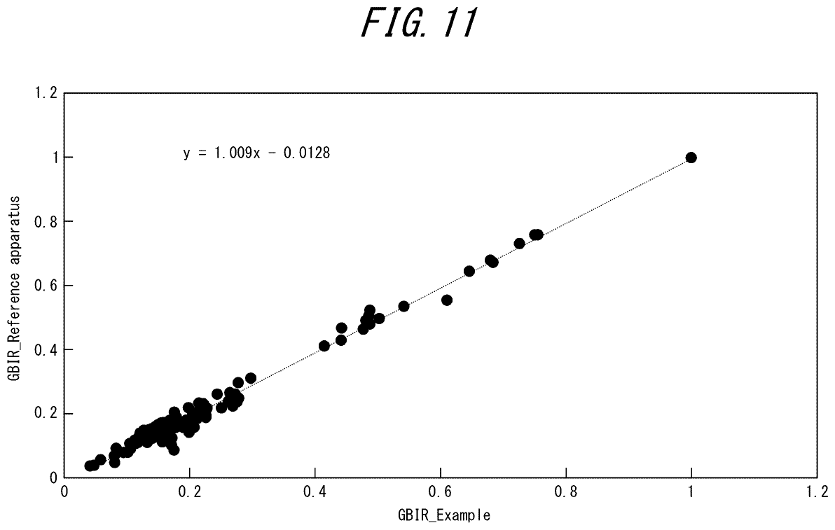

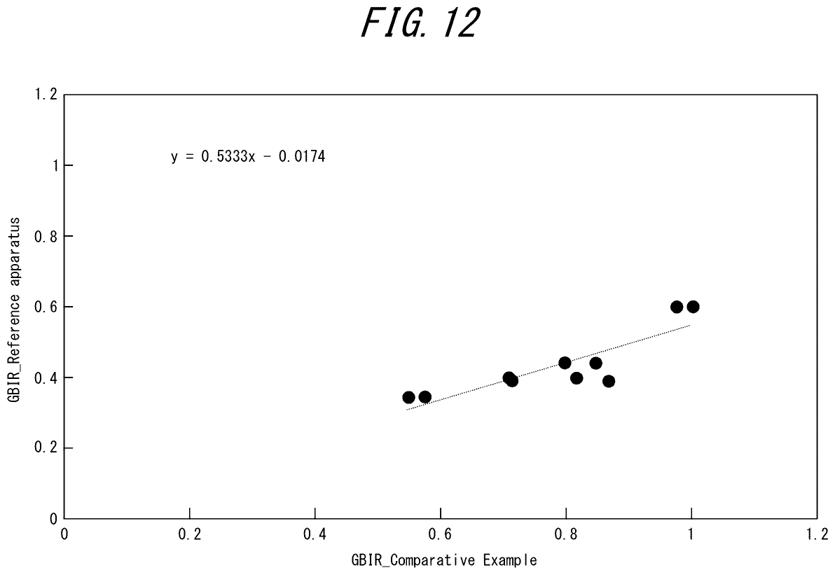

FIG. 11 is a graph representing the relationship between the GBIR value results in Examples and the GBIR value results from the flatness measuring instrument (WaferSight), and FIG. 12 is a graph representing the relationship between the GBIR value results in Comparative Examples and the GBIR value results from the flatness measuring instrument (WaferSight). In FIGS. 11 and 12, the vertical and horizontal axes are normalized. In FIGS. 11 and 12, the closer the slope of the first-order approximation formula is to “1”, the higher the correlation between Examples or Comparative Examples, and the flatness measuring instrument (WaferSight).

Comparison of FIGS. 11 and 12 indicates that the GBIR values were obtained more accurately in Examples than in Comparative Examples. This indicates that the thickness of the workpieces were measured more accurately in Examples than in Comparative Examples.

### REFERENCE SIGNS LIST

1 Apparatus for measuring a thickness of a workpiece
2 Enclosure
2a Carry-in port
2b Exhaust slit
3 Measurement section
3a Spectral interferometric sensor
3b Holding section
3c Drive section
4 Rectifier
5 Storage section
6 Second partition
7 Perforated plate
8 Equipment
9 Vibration-isolation mechanism
10a, 10b Temperature sensor
100 System for polishing a workpiece
101 Workpiece carry-in unit
102 Polishing unit
103 Cleaning unit
104 Drying unit
105 Workpiece carry-out unit
106 FOUP
S Air flow

1. An apparatus for measuring a thickness of a workpiece, comprising
an enclosure;
a measurement section disposed inside the enclosure for measuring the thickness of the workpiece; and
a rectifier disposed inside the enclosure for rectifying airflow inside the enclosure,
wherein the measurement section is provided with a spectral interferometric sensor.

2. The apparatus for measuring a thickness of a workpiece according to claim 1, further comprising a storage section for storing equipment.

3. The apparatus for measuring a thickness of a workpiece according to claim 2, wherein the rectifier, the measurement section, and the storage section are arranged in this order from an upper side in the enclosure,
a first partition is provided between the rectifier and the measurement section,
a second partition is provided between the measurement section and the storage section,
a first opening is provided in the first partition, and
a second opening is provided in the second partition.

4. The apparatus for measuring a thickness of a workpiece according to claim 3, wherein the second partition with the second opening is a perforated plate.

5. The apparatus for measuring a thickness of a workpiece according to claim 2, wherein an exhaust slit is provided on a side portion of the enclosure that defines the storage section.

6. The apparatus for measuring a thickness of a workpiece according to claim 1, wherein a bottom portion of the enclosure is made of a perforated plate.

7. The apparatus for measuring a thickness of a workpiece according to claim 1, wherein a temperature sensor is disposed at least inside the enclosure.

8. The apparatus for measuring a thickness of a workpiece according to claim 1, wherein the workpiece is a semiconductor wafer.

9. A system for polishing a workpiece, comprising a workpiece carry-in unit and a workpiece carry-out unit,
wherein the apparatus for measuring a thickness of a workpiece according to claim 1 is installed in each of the workpiece carry-in unit and the workpiece carry-out unit.

10. The system for polishing a workpiece according to claim 9, further comprising a polishing unit, a cleaning unit, and a drying unit.

11. The system for polishing a workpiece according to claim 9, wherein the workpiece is a semiconductor wafer.

12. A method for measuring a thickness of a workpiece in which the thickness of the workpiece is measured using a measurement section comprising a spectral interferometric sensor, wherein
the measurement section is disposed inside an enclosure, and
the thickness of the workpiece is measured by the measurement section while rectifying airflow in the enclosure using a rectifier disposed inside the enclosure.

13. The method for measuring a thickness of a workpiece according to claim 12, including
monitoring a temperature of at least inside the enclosure by a temperature sensor disposed at least inside the enclosure, and estimating an appropriate measurement time for measuring the thickness of the workpiece based on a result of the monitored temperature measurement, and
measuring the thickness of the workpiece with the estimated measurement time.

14. The method for measuring a thickness of a workpiece according to claim 12, including
monitoring a temperature of at least inside the enclosure by a temperature sensor disposed at least inside the enclosure, and determining pass or fail on measurement accuracy based on a result of the monitored temperature measurement.

15. The method for measuring a thickness of a workpiece according to claim 12, wherein the workpiece is a semiconductor wafer.
